(19) United States
(12) Patent Application Publication
(10) Pub. No.: US 2015/0209794 A1
(43) Pub. Date: Jul. 30, 2015

(54) MODIFIED MICRONIZATION DEVICE AND METHOD THEREOF

(71) Applicants: Tihomer Lelas, Zagreb (HR); Peter Ost, Stadtbergen (DE)

(72) Inventors: Tihomer Lelas, Zagreb (HR); Peter Ost, Stadtbergen (DE)

(73) Assignee: OEKOMINERAL AG, Brugg (CH)

(21) Appl. No.: 14/165,638

(22) Filed: Jan. 28, 2014

(51) Int. Cl. B02C 13/20; B02C 13/28

(52) U.S. Cl. CPC B02C 13/205; B02C 13/28; B02C 2013/2808; B02C 13/288

(57) ABSTRACT

A device and method for operating the same for the micronization of substances in a device having two rotors driven in a direction (w) opposite to each other, each rotor carrying at least one row of multiple hitting elements forming a ring, said rings being arranged concentrically in, the rings of the different rotors engaging alternately with one another, the hitting elements being suitably arranged to provide transportation of the substance from inside the rings to the outside by effecting a suitable airflow, at least two, directly adjoining rings carrying hitting elements with different foot print wherein at least a first ring is equipped with trapezoidal hitting elements with trapezoidal foot print and at least one other ring, directly adjoining the first ring is equipped with triangular hitting elements with triangular foot print.

### RELATED APPLICATION

This application relates to, but does not claim priority from, EPO 12 177 709.8 filed Jul. 24, 2012, the entire contents of which are incorporated herein by reference.

### FIGURE SELECTED FOR PUBLICATION

FIG. 7

### BACKGROUND OF THE INVENTION

1. Field of the Invention

The present invention relates to a device for micronization and a method for operating such device.

2. Description of the Related Art

New physical properties, bioavailability and bio-efficacy of solid substances are often intrinsically related to the primary particle size and proportion of amorphous surface area. Particle size reduction by top-down processing i.e. milling is one of various strategies for improving solubility and reactive characteristics of poorly water-soluble ingredients. Thus, many attempts have been conducted to obtain good bioavailability achieved by creating an amorphous product.

Micronization is a highly effective kind of milling which allows a direct production of very fine particles, typically 5-50 μm, from relatively coarse-grained starting material, particle size, e.g. 0.1-1 mm.

Technological operation of micronization is widely used in production of active substances and excipients for pharmaceutical, cosmetic, and agrochemical industries, in chemical industry (e.g. fillers, pigments), and in many other fields.

Micronization can be accomplished by a prolonged milling in various classical mills (ball mill, jet mill, disintegrators etc.), wherein the milling process is based mainly on collisions of particles between themselves or with hitting elements of a milling device.

Disintegrators of various types are known from the prior art Examples of such disintegrators are for example disclosed in U.S. Pat. No. 4,406,409 A1 and HR 990 263 A2, the contents of each of which are incorporated herein by reference. Those disintegrators are principally based on the concept of two high-speed opposite rotating discs. The discs bear particular hitting elements, blades, which partially collide with particles directly, but mostly targeted to create an efficient airflow by mimicking turbines, driving particles into mutual collisions. In literature, there are described devices with various shaped blades on the discs:
1. round-shaped blades;
2. blades in the shape of elongated plates; and
3. blades in the shape of slightly curved plates;
   without or with additional particular mechanic details (e.g. indented hitting surface) which eventually improve a course of micronization process due affecting airflow.

### ASPECTS AND SUMMARY OF THE INVENTION

In response, the present invention provides an improved device for micronization based on the concept of desintegrator with two opposite rotating discs, known also as disintegration. The present device modified for significant improvement in micronization process. The main improvement of the present invention is a modification of particle hitting elements or blades, in positioning and shape. Along each of disc in two or several layers results in significant improvement of micronization. Discs are situated within the micronizer in a way that the layers of blades of first and second disc enter into each other's.

Particles of the material being micronized, carried by centrifugal force from the center of the device, pass through several layers of cubical and triangular shaped blades in the way to collide repeatedly with other particles and between rows of blades. Additionally, triangular blades, oppose to centrifugal particle flow by forcing them into repeated collisions, resulting in improved reduction of their size.

The present invention also provides a modified device for an improved milling process method, which is based on the concept of a disintegrator.

A device for micronization of substances according to the present invention comprises two rotors driven in a direction opposite to each other, each rotor carrying at least one row of multiple hitting elements forming a ring, said rings being arranged concentrically the rings of the different rotors engaging alternately with one another, the hitting elements being suitably arranged to provide transportation of the substance from inside the rings to the outside by effecting a suitable airflow, at least two directly adjoining rings carrying hitting elements with different foot print wherein at least a first ring is equipped with trapezoidal hitting elements with trapezoidal foot print and at least one other ring directly adjoining the first ring is equipped with triangular hitting elements with triangular foot print.

Present research showed that the footprint of the hitting elements has significant influence on the results of micronization. If was found out that with reduced particle size the effect of inter particle collisions has less influence on the micronization result and thus conventional turbine-like footprints of the hitting elements get less effective. The hitting elements according to the present invention provide a suitable air flow to effect inter particle collisions but also provide improved collisions between the particles and the hitting elements as well as permanent milling between the hitting elements of directly adjoining rings.

In another embodiment of the device one side of the triangular hitting elements and/or one of the parallel sides of the trapezoidal hitting elements is perpendicularly oriented to a radius crossing the hitting element.

Due to the arrangement of the hitting elements perpendicular to a radius crossing the respective hitting elements are suitably arranged to provide parallel arranged surfaces for milling of the substance between adjoining rings.

In a further embodiment of the device the trapezoidal hitting elements are of rectangular foot print.

With a rectangular footprint the trapezoidal hitting elements may be of generally cubical shape. Compared to other shapes cubical hitting elements are easier to produce and thus cheaper in production.

It was unexpectedly found that the shape of the hitting elements of one rotating disc in a form of cubes and other in a form of tightly positioned triangular shapes (FIG. 5), unexpectedly results in significantly improved efficacy of micronization.

In another embodiment of the present device the triangular hitting elements are of basically right angled triangular foot print.

The right angled triangular footprint allows manufacturing of the triangular hitting elements with rectangular base elements that are divided diagonally. It is thus possible to use base elements with rectangular footprint to manufacture both, the rectangular hitting elements and the triangular hitting elements.

In a preferred embodiment the perpendicularly oriented side of the triangular hitting elements is the longer cathetus. Preferably the longest cathetus is oriented to the outward circumference of it's respective ring.

The longer cathetus of the triangular hitting elements is thus tangentially oriented and may serve for milling. The milling will take place between the tangentially oriented surface of the triangular hitting elements and surfaces of hitting elements of a cicumferring and directly adjoining ring. Furthermore the triangular hitting elements thus provide for sufficient air flow from the center of the rings to the outside.

In another embodiment the longest side of the triangular hitting elements is oriented in front in direction of rotation of the respective rotor.

Particularly in combination with right angled triangular hitting elements with the longest cathetus oriented to the outward circumference of the respective ring this embodiment directs the particles in backward loops, i.e. backward in substantially radial direction, thus resulting in extended time within the device and thus more inter particle collisions.

In another embodiment the hitting elements of directly adjoining rings are suitably arranged to provide milling between the hitting elements of adjacent rings.

As with shrinking particle size inter particle collisions get less important for size reduction of the particles, permanent milling between the hitting elements of adjacent rings becomes more relevant for the disintegration. By arranging the hitting elements of directly adjoining rings in this manner disintegration results are further enhanced.

Each ring may carry a number of hitting elements equivalent to the diameter in cm of the respective ring.

The number of hitting elements per ring obtained by this rule provides an optimal ratio of hitting elements to spaces between the hitting elements and thus further enhances the efficacy of disintegration.

The hitting elements may be made of stainless steel or ceramics and/or coated with industrial diamond or ruby.

The above materials and/or coatings provide high durability of the hitting elements as well as high availability of the used materials.

To achieve the above-mentioned advantage in manufacture of the hitting elements out of identical base elements, the triangular hitting elements and the trapezoidal hitting elements may have at least two sides with coinciding length.

Thus not only rectangular but also trapezoidal elements can serve as base elements for both, trapezoidal and triangular hitting elements.QQ

The above and other aspects, features and advantages of the present invention will become apparent from the following description read in conjunction with the accompanying drawings, in which like reference numerals designate the same elements.

### BRIEF DESCRIPTION OF THE DRAWINGS

FIG. 1 shows a perspective view of a disintegrator.

FIG. 2 shows a sectional view of the disintegrator FIG. 1.

FIG. 3 shows a first embodiment of hitting elements according to the state of the art.

FIG. 4 shows a second embodiment of hitting elements according to the state of the art.

FIGS. 5 and 6 show enlarged sections of FIG. 3 and FIG. 4.

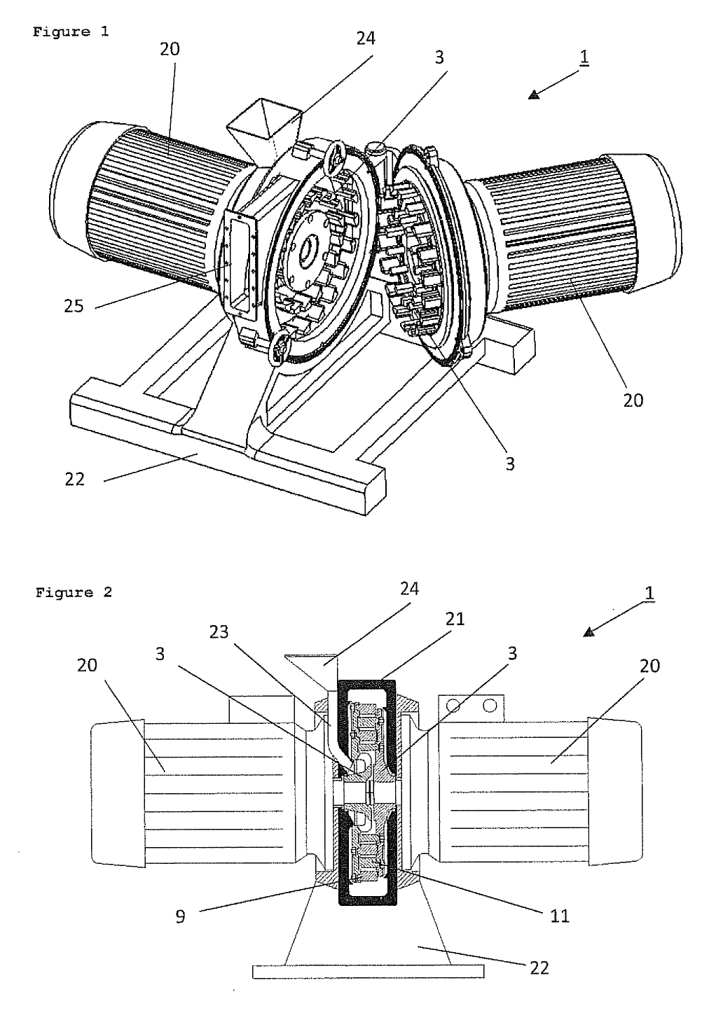

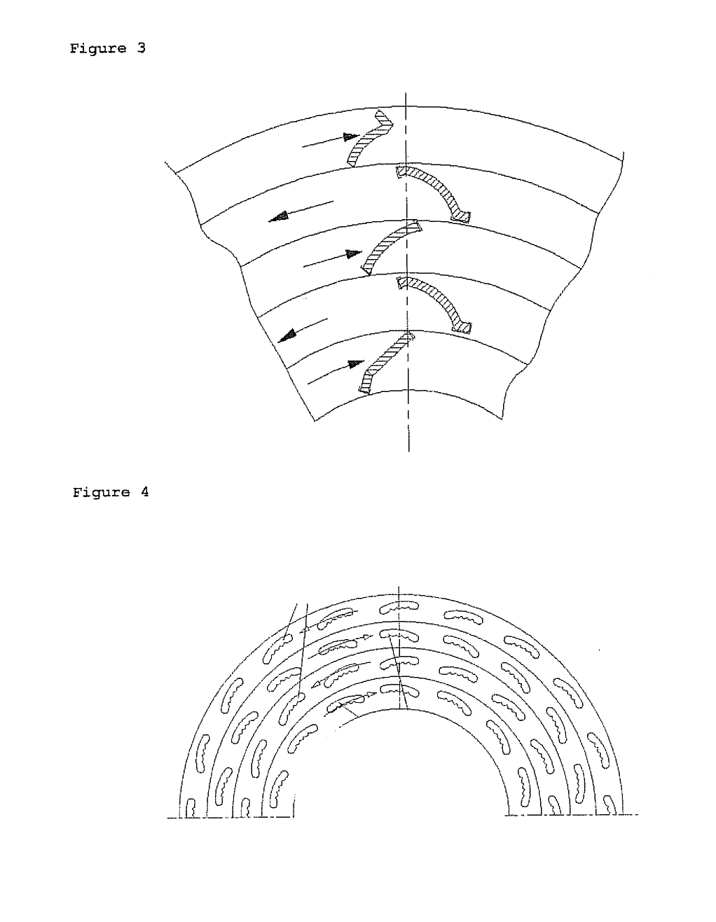

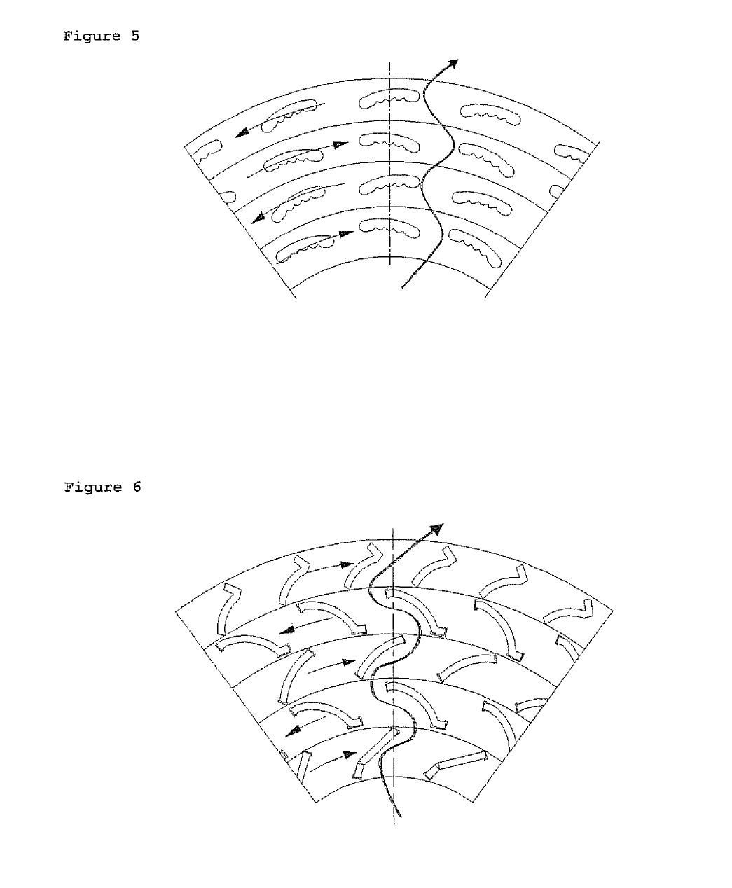

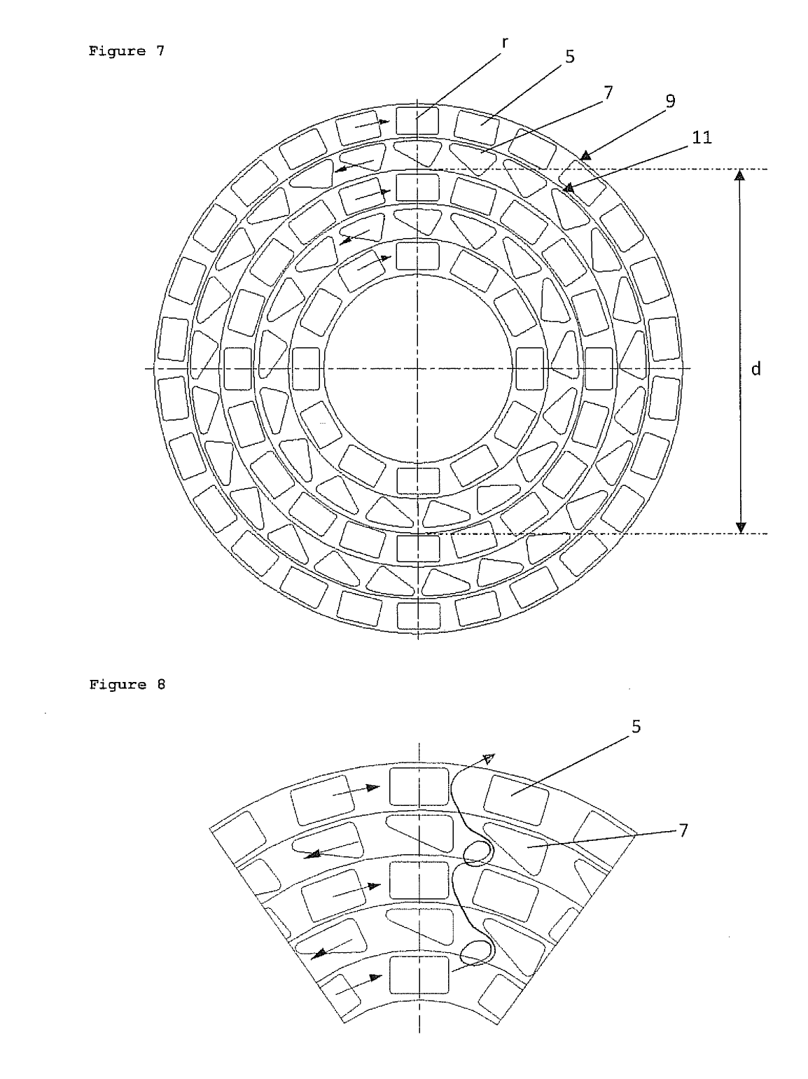

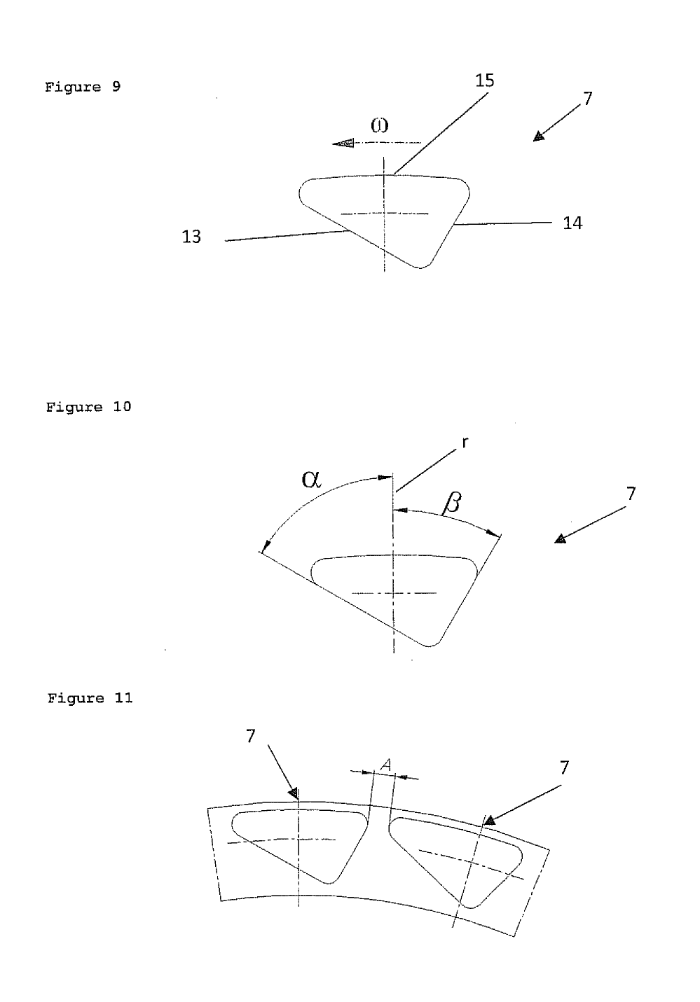

FIG. 7 shows a sectional view of the rotors according to an embodiment of the present invention.

FIG. 8 shows an enlarged section of FIG. 7.

FIGS. 9-11 show the hitting elements according to FIGS. 7 and 8 in enlarged view.

### DETAILED DESCRIPTION OF THE PREFERRED EMBODIMENTS

Reference will now be made in detail to embodiments of the invention. Wherever possible, same or similar reference numerals are used in the drawings and the description to refer to the same or like parts or steps. The drawings are in simplified form and are not to precise scale. The word ‘couple’ and similar terms do not necessarily denote direct and immediate connections, but also include connections through intermediate elements or devices. For purposes of convenience and clarity only, directional (up/down, etc.) or motional (forward/back, etc.) terms may be used with respect to the drawings. These and similar directional terms should not be construed to limit the scope in any manner. It will also be understood that other embodiments may be utilized without departing from the scope of the present invention, and that the detailed description is not to be taken in a limiting sense, and that elements may be differently positioned, or otherwise noted as in the appended claims without requirements of the written description being required thereto.

As used throughout, ranges are used as a shorthand for describing each and every value that is within the range. Any value within the range can be selected as the terminus of the range. In addition, all references cited herein are hereby incorporated by reference in their entireties. In the event of a conflict with a definition of the present disclosure and that of a cited reference, the present disclosure controls.

Various operations may be described as multiple discrete operations in turn, in a manner that may be helpful in understanding embodiments of the present invention; however, the order of description should not be construed to imply that these operations are order dependent.

The disintegrator 1 according to FIG. 1 is equipped with two electro motors 20 arranged opposite to each other and rotating in opposite direction co. Each electro motor 20 is coupled directly or indirectly via a gearbox to a rotor 3 that is equipped with multiple concentrically arranged rings 9, 11 of hitting elements 5, 7 (hereinafter also called blades). The rings 9, 11 of hitting elements 5, 7 of the two rotors 3 alternately engage with each other thus adjacent rings 9, 11 of hitting elements 5, 7 rotating in opposite direction co. The rotors 3 are encapsulated in a casing 21 that may be opened according to the illustration in FIG. 1.

The whole disintegrator 1 is located on a mount 22, e.g. a base frame that carries the electro motors 20 and the oppositely rotating rotors 3.

The disintegrator 1 exhibits a filler 23 with a hopper 24. As can be seen from FIG. 2 the filler 23 directs the material for micronization to the center of the rotors 3. A sufficient airflow generated by the rotors 3 rotating in opposite direction co transports the material from the center of the rotors 3 to an outlet 25 at the circumference of the rotors causing multiple inter particle and particle-hitting-element collisions. At the outlet 25 the micronized material exits the casing 21 of the disintegrator 1 and either may be collected or again fed into the disintegrator 1.

FIG. 2 clearly shows how the rings 9, 11 of hitting elements 5, 7 of the rotors 3 alternatively engage one another thus adjacent rings 9, 11 of hitting elements rotating in opposite directions co.

FIGS. 3 to 6 show different views of hitting elements according to the prior art.

The hitting elements depicted in FIGS. 3 and 4 are of bladelike footprint that mainly generates an airflow transporting particles from the center of the rotors 3 to the circumference, thus generating inter particle collisions. However due to the pitch of the blades the time the particles stay within the disintegrator 1 is quite low.

FIGS. 5 and 6 show exemplary traces of articles from the center of the rotors 3 to the outer circumference where the particle exit the disintegrator 1.

The improved device 1 claimed according to the present invention has the similar device construction like the disintegrators 1 from the prior art [J. Durek: Disintegrator and the method for the operation thereof, U.S. Pat. No. 4,406,409 A], [T. Lelas: Device for micronizing materials, HR990263 A2 (1999)] shown in FIGS. 1 and 2.

An embodiment of a blade design (design of the hitting elements) according to the present invention is shown in FIGS. 5 to 11. In this present embodiment a first ring 9 of trapezoidal blades carries hitting elements 5 with rectangular footprint and thus ob generally cubic shape. Another ring 11, directly adjoining the first ring 9 carries triangular hitting elements 7 with a footprint of a right angled triangle. These triangular hitting elements 7 are tightly positioned and of generally prismatic shape. The different footprints of the blades 5, 7 are shown in FIG. 5.

FIG. 5 shows a cross-section in the plane of rotation of the hitting elements 5, 7 thus depicting the different footprints of the hitting elements 5, 7 on the different rotors 3.

In the present embodiment the rotor 3 rotating in clockwise manner carries tree rings 9 of trapezoidal hitting elements 5 with rectangular footprint. The other rotor 3 (in the depicted view rotating counterclockwise) carries two rings 11 of triangular hitting elements 7 with triangular footprint. The rings 9, 11 of hitting elements 5, 7 engage alternately thus on a ring 9 rotating in clockwise manner follows a ring 11 rotating in opposite direction, i.e. counterclockwise manner.

Due to the different footprints of the hitting elements 5, 7 and due to their arrangement the present embodiment provides an elongated time of the particles within the disintegrator 1 and thus a enlarged number of inter particle collisions, permanent milling between the hitting elements 5, 7 of adjacent rings 9, 11 and a enlarged number of collisions between particles and the hitting elements 5, 7.

The trace of a particle being micronized in a disintegrator 1 according to the present embodiment is depicted in FIG. 8. Due to the arrangement of the hitting elements 5, 7 the particles move in a loope-like manner thus resulting in a prolonged time within the disintegrator 1.

The footprint of the triangular hitting elements 7 and their arrangement on their rotor 3 is depicted in FIGS. 9 to 11.

FIG. 9 shows an enlarged cross-section of a triangular hitting element 7 according to the present embodiment. The hitting element 7 is of basically triangular footprint with rounded edges. As depicted in FIG. 9 the footprint is in the shape of a right angled triangle. The hypotenuse 15 of the right angled triangle is oriented tangentially to the outward circumference of the ring 11 built by the hitting elements 7 of it's respective ring.11

The arrow in FIG. 9 indicates the direction of rotation co of the respective hitting element 7, the longer cathetus 13 of the right enabled triangle thus being forward oriented.

According to FIG. 10 a center of the hypotenuse 15 of the triangular shaped footprint is perpendicularly cut by a radius r of the respective ring 11. The longer cathetus 13 thus is inclined relative to the radius r by an angle a of 60 degrees. Accordingly (due to the fact that the triangle is right angled) the other cathetus 14 is inclined relative to the radius r by an angle β of minus 30 degrees.

FIG. 11 depicts two triangular hitting elements 7 arranged in a ring like manner. The hitting elements 7 are spaced from one another by a distance A of 15-100% of the length of the hitting elements 7.

The longest side of the rectangular hitting elements 5 for example may be 30 mm. Accordingly the longer cathetus 13 of the triangular hitting elements 7 may be of the same length.

The course of the micronization process in the device 1 according to the present embodiment is actually the same as in the micronizer with hitting elements as disclosed in the prior art (shown in FIGS. 3 and 4). Material being micronized is added in the hopper 24 of the filler 23. The latter brings the material into a central part of rotating discs 3 beside their axes. Due to a strong centrifugal force, particles of material being micronized pass through two or several layers of rotating hitting elements 5, 7 (blades) of opposite discs rotating at high speed (about 5000-8000 rounds per minute) in opposite direction.

The influence of the shape of the blades on the efficiency the micronization has been studied by the use of the micronization device shown in FIGS. 1 and 2 from the prior art of the following technical characteristics:
(i) diameter of discs (0) of micronizer was 370 mm;
(ii) number of layers of hitting elements (blades) on the discs was 3 on primary and 2 on secondary disc;
(iii) number of blades on each of wreaths of discs was 20/16 (outer/inner wreath) from one side; and 18/16 (outer/inner wreath) from the other side of the micronizer;
(iv) the rotation velocity was 10000 rpm.

The micronization device was equipped with two identical 20 kW power electro-motors that work at 220 V and 50 Hz.

Natural zeolite clinoptilolite, of the general formula:

(Meⁿ⁺)_{x/n}[(AlO₂)ₓ(SiO₂)_{y}]·mH₂O,

wherein Me=Na, K, Mg, Ca, Fe, Zn, Mn, Cr, was selected as a model substance of a hardness of 4 according to Mohs' scale. The starting material of an average particles size of 50-100 μm, was obtained from Zeocem a.s., Slovakia. The reason why zeolite is chosen is due to its NH₄+ sorption and retention capacity. It has been already demonstrated that zeolite can have significant improvement in sorption capacity, if micronized below one μm.

1 kg of each sample of same zeolite clinoptilolite was micronized by using the device according to the prior art and three different hitting elements as depicted in FIGS. 5, 6 and B. The disintegrators are characterized by the following data:
1. Plates formed according to U.S. Pat. No. 4,406,409 A (FIG. 5; Micronization-1);
2. Slightly curved and indented plates according to HR990263 A2 (FIG. 6; Micronizationt-2); and
3. The hitting elements according to the present invention (FIG. 8; Micronization-3)

Prepared samples of micronized zeolite mineral were analyzed for particles size using a Malvern MasterSizer 2000 instrument and for NH₄+ ion sorption capacity with aqueous NH4Cl solution measured with an ion chromatograph DX-120 Dionex from the United States. The results of Micronization-1, Micronization-2 and Micronization-3 are shown in Table 1 and 2.

Table 1 shows the influence of the various shapes of hitting elements (blades) from different micronizing discs (FIGS. 6 and 8) on efficacy of micronization of zeolite clinoptilolite of starting particle size 50-100 μm. The goal was to achieve larger amount of submicron particles.

TABLE 1

| | | MICRO- | MICRO- |
|---|---|---|---|
| | MICRONIZATION-1 | NIZATION-2 | NIZATION-3 |
| Particles | Volume (%) | Volume (%) | Volume (%) |
| size (μ.m.) | under | under | under |
| 0.105 | 0.00 | 0.00 | 0.00 |
| 0.120 | 0.00 | 0.00 | 0.00 |
| 0.138 | 0.00 | 0.00 | 0.00 |
| 0.158 | 0.00 | 0.00 | 0.00 |
| 0.182 | 0.00 | 0.00 | 0.01 |
| 0.209 | 0.00 | 0.02 | 0.08 |
| 0.240 | 0.00 | 0.32 | 0.47 |
| 0.275 | 0.00 | 0.62 | 1.44 |
| 0.316 | 0.02 | 1.04 | 2.43 |
| 0.363 | 0.07 | 1.62 | 3.79 |
| 0.417 | 0.15 | 2.16 | 5.54 |
| 0.479 | 0.29 | 3.18 | 7.71 |
| 0.550 | 0.79 | 4.11 | 9.84 |
| 0.631 | 1.12 | 5.36 | 12.44 |
| 0.724 | 1.89 | 6.96 | 15.03 |
| 0.832 | 2.44 | 8.41 | 18.13 |
| 0.955 | 3.66 | 10.02 | 21.72 |
| 1.096 | 5.12 | 13.16 | 26.80 |

Table 2 shows the influence of the various shapes of hitting elements from different micronizing discs (FIGS. 5, 6 and 8) on particle specific surface are of zeolite clinoptilolite of starting particle specific surface area 0.9 m²/g.

TABLE 2

| | | MICRO- | MICRO- |
|---|---|---|---|
| | MICRONIZATION 1 | NIZATION 2 | NIZATION 3 |
| Specific | 1.9 | 3.2 | 6.7 |
| Surface Area | | | |
| m²/g | | | |

Table 3 shows the influence of the various shapes of hitting elements from different micronizing discs (FIGS. 5, 6 and 8) on NH₄+ sorption of zeolite clinoptilolite of starting capacity 0.23 mmol/g.

TABLE 3

| | | MICRO- | MICRO- |
|---|---|---|---|
| | MICRONIZATION-1 | NIZATION-2 | NIZATION-3 |
| NH₄+ Sorption | 0.48 | 0.78 | 0.94 |
| Capacity | | | |
| mmol/g | | | |

The results show that the process of MICRONIZATION-3 (FIG. 8) with cube shaped hitting elements on one disc and tightly positioned triangular hitting elements on the other disc is superior to the other processes. It is also shown that MICRONIZATION-3 particles have much larger specific surface and capacity of ion sorption than those processed by other micronization types.

Further experiments show how repeated micronization (5 times in the same device, but with differently designed hitting elements affects particle size and crystalline surface deformation in order to enhance an amorphous portion of the surface and consequently improve solubility of poorly soluble pharmaceutically active ingredients.

1 kg of each sample of ursolic acid (98% purity, Sigma Aldrich) of an average particle size of 30 pm was micronized five times in devices having different hitting elements. The discs were cooled through a feeder opening with liquid nitrogen spraying to avoid overheating of the heat-sensitive substance. The device used was according to the prior art while the hitting elements used are shown in FIGS. 5, 6 and 8.

The micronized samples were analyzed for particle size (Malvern MasterSizer 2000), while the extent of crystalline disorder of particles was quantified with isothermal calorimetry (IC TAM 3, TA instruments, USA). Data was recorded with proprietary software Digitam 4.2.

Table 4 shows the influence of the various shapes of hitting elements of different micronizing discs (FIGS. 5, 6 and 8) on ursolic acid particle size after five repeated micronization procedures.D

TABLE 4

| | | | MICRO- |
|---|---|---|---|
| | MICRONIZATIO-1 | MICRONIZATION-2 | NIZATION-3 |
| Particles | Volume (%) | Volume (%) | Volume (%) |
| size (μ.m.) | under | under | under |
| 0.105 | 0.00 | 0.00 | 0.00 |
| 0.120 | 0.00 | 0.00 | 0.00 |
| 0.138 | 0.00 | 0.00 | 0.00 |
| 0.158 | 0.00 | 0.00 | 0.28 |
| 0.182 | 0.00 | 0.00 | 1.38 |
| 0.209 | 0.00 | 0.12 | 2.73 |
| 0.240 | 0.00 | 0.46 | 3.69 |
| 0.275 | 0.01 | 1.19 | 5.39 |
| 0.316 | 0.06 | 1.97 | 8.42 |
| 0.363 | 0.23 | 2.83 | 11.76 |
| 0.417 | 0.50 | 4.09 | 14.01 |
| 0.479 | 0.87 | 5.36 | 19.32 |
| 0.550 | 1.12 | 7.01 | 25.19 |
| 0.631 | 2.02 | 9.13 | 31.12 |
| 0.724 | 3.29 | 11.51 | 36.14 |
| 0.832 | 4.78 | 13.61 | 42.72 |
| 0.955 | 6.12 | 16.29 | 50.02 |
| 1.096 | 8.44 | 19.17 | 59.80 |

Table 5 shows the influence of the various shapes of hitting elements from different micronizing discs (FIGS. 3, 4 and 5) on amorphous content of ursolic acid after five repeated micronization procedures.

TABLE 5

| | | M1CRO- | MICRO- |
|---|---|---|---|
| | MICRONIZATION-1 | NIZATION-2 | NIZATION-3 |
| Amorphous | 3.68 | 6.12 | 19.23 |
| Content | | | |
| (%, w/w) | | | |

The tables above show that a reduction of particle size is not proportional to the number of repeated micronization processes; this is particularly notable in MICRONIZATION-1 and MICRONIZATION-2. It appears the smaller the particles are, the air friction affects them more, resulting in weaker collisions. This is predominant in discs having hitting elements with “turbine-like” design according to the state of the art devices. The hitting elements according to FIG. 7 show superior results, efficiently reducing particle size and inducing significant proportion of amorphous surface content.

Generally, it seems that major reason for effective and useful micronization from the design described in FIGS. 7-11 comes from the fact that the majority of particles is pushed back into compact repeated collisions (FIG. 8) by the layers of tightly position hitting elements having extruded triangle shape as shown in FIGS. 7-11. This way, particles return and collide repeatedly with other particles or hitting elements in the previous layer, while only a small amount of particles passes onto next flow layer. The flow of particles from this invention is shown in FIG. 8. Such flow results in superior micronization compared to previous disintegrator devices, which relied mostly on turbine-like micronization effect. Particularly, airflow driven particle collisions, dominating in previous disintegrators are not sufficient for micronization below one (1) μm. Even after several repeated micronizing processes in prior art devices, particles do not reduce in size significantly, because airflow driven collisions become less important due to increased air friction and reduced kinetic energy of the particles. The smaller the particles become, the more air friction reduces impact velocity. The present invention demonstrates the importance of tight contact with the blades, which is important for adequate size reduction. Airflow based particle movements is used as vehicle to enable particle exit from the device by centrifugal force. To our best knowledge, it seems that the present invention is accomplishing superior micronization through four (4) major factors a) minimal air friction, b) compact particle inter-collisions, c) collision of particles with disc blades and, thus permanent milling between the different layers of blades resulting in improved micronization compared to state of the art devices.

The Use of the Device For Micronization From the Present Invention

The discs and hitting elements from the micronization device of the present invention can be built from various materials such as stainless steel 316, tungsten carbide or similar depending on the hardness of the materials to be micronized.

The micronization device of the present invention can be successfully used for milling of pure substances or mixtures of several substances, organic, inorganic or mixed compositions. Specifically it can be used for the processing of substances from the classes of raw materials, intermediates or final products in pharmaceutical, cosmetic, food, agrochemical or construction industry, in various kinds of chemical industries, agriculture, and in other fields of production.

A micronization process could induce defects in the crystalline network: these defects and increase of amorphous surface can improve the dissolubility of poorly soluble drugs. For example one such pharmaceutically active poorly soluble substance, is anti-ursodeoxycholic acid (UDCA). UDCA's solubility can be significantly improved by the use of the present device in a cost effective way, thus achieving better oral bioavailability.

The present invention can potentially enhance qualitative characteristics of various food ingredients, enabling cost-effective production processes and avoiding the need for chemical interventions. Micronizing macromolecular compounds can result in their more efficient processing, better solubility and oral bioavailability. Such modified molecules positively influence taste and nutritive characteristics. Micronized polysaccharides with high molecular mass, can also improve gelling characteristic and stability of gelatinous substances. Ratio of soluble fibers in food can be also increased by application of the present invention (breakage of chains, surface area increase) which is otherwise established only by addition of enzymes and implementation of heating process. During extraction of active ingredients from dry substances, the prior use of the present device on those substances can significantly improve related extraction time/quality and reduce the need for organic solvents due to smaller raw material particle size, increase of specific surface (better contact of solvent and raw material) and breakage of the bonds between active ingredient and raw material.

The present device can be also used for cost-effective processing of silica (including desert sand) to achieve more reactive nano size particles that can be used as advanced concrete additive for improvement of concrete properties or as added in certain percentage for brick production.

Herein mentioned examples of the use of the micronization device from the present invention are only illustrative and do not include all possible technical applications.

### EXAMPLES

### Example 1

### Preparation of Pterostilbene Nanoparticles For Better Solubility—Bioavailability

1.00 kg of Pterostilbene (98% purity, Organic Herb, China) 50 pm of crystalline particles as model substance were subjected to micronization from present invention with additional maintaining of low temperature (20° C.) of substance via slow liquid nitrogen stream flow addition through neck feeder. In this preparation discs with blades in the shape of cubes and extruded triangles were used (FIG. 4), according to the present invention.

Such prepared samples of micronized Pterostilbene were subjected to particles size analyses and water solubility measurement. Average particle size after seven repeated processes of micronization were around 0.4 μm and significantly increased amorphous surface ratio (34% w/W). Solubility increased from 23 μg/ml, to 128 μg/ml.Z

### Example 2

### Preparation of Si0₂ Nanoparticles For Concrete Additive

1.00 kg of white Si0₂ sand from Drava River was commercially obtained from the store in Croatia. The average particle size was between 0.1-2 mm. In this preparation discs with blades in the shape of cubes and extruded triangles were used (FIG. 4), according to the present invention, but all together reinforced with tungsten carbide coating. The average particle size of sand after nine repeated micronization processes were 0.35 μm.

### LIST OF REFERENCE NUMERALS

1 device for micronization/disintegrator
3 rotors
5 trapezoidal/rectangular hitting element
7 triangular hitting element
9 first ring
11 other ring
13 longer cathetus
14 other cathetus
15 hypotenuse
20 electro motor
21 casing
22 mount
23 filler
24 hopper
A distance
d diameter
r radius
\acute{ω} direction of rotation

Having described at least one of the preferred embodiments of the present invention with reference to the accompanying drawings, it will be apparent to those skills that the invention is not limited to those precise embodiments, and that various modifications and variations can be made in the presently disclosed system without departing from the scope or spirit of the invention. Thus, it is intended that the present disclosure cover modifications and variations of this disclosure provided they come within the scope of the appended claims and their equivalents.

What is claimed is:

1. A micronization device, operative for the micronization of substances, comprising:
a first and a second rotors driven in a direction (w) opposite to each other;
each said rotor carrying at least one row of a plurality of hitting elements forming a ring;
respective said rings being arranged concentrically in the rings of the different rotors engaging alternately with one another;
said hitting elements being suitably arranged to provide transportation of the substances from an inside of the rings to an outside of the rings by effecting a suitable airflow therealong; and
at least two directly adjoining rings carrying said hitting elements with different foot print characterized in that at least a first ring is equipped with trapezoidal hitting elements with trapezoidal foot print and at least one other ring, directly adjoining the first ring, is equipped with a plurality of triangular hitting elements with triangular foot print.

2. The micronization device, according to claim 1, wherein:
on at least one of said one side of the triangular hitting elements and said one of the parallel sides of the trapezoidal hitting elements is perpendicularly oriented to a radius (r) crossing said hitting element.

3. The micronization device, according to claim 2, wherein:
said the trapezoidal hitting elements are of rectangular foot print.

4. The micronization device, according to claim 3, wherein:
the triangular hitting elements are of basically right angled triangular foot print.

5. The micronization device, according to claim 4, wherein:
a perpendicularly oriented side of the triangular hitting elements is a longer cathetus or a hypotenuse of said triangle.

6. The micronization device, according to claim 4, wherein:
one of said longer cathetus and a longest side of the triangular hitting elements is oriented in front in direction of rotation (\acute{ω}) of the respective rotor.

7. The micronization device, according to claim 4, wherein:
said hitting elements of directly adjoining rings are suitably arranged to provide mulling between the hitting elements of adjacent rings.

8. The micronization device, according to claim 4, wherein:
each said ring carries a number of hitting elements equivalent to the diameter (d) in cm of the respective ring.

9. The micronization device, according to claim 4, wherein:
said hitting elements are made of one a group consisting of: stainless steel, ceramics, material coated with industrial diamond, and material coated with ruby.

10. The micronization device, according to claim 4, wherein:
the triangular hitting elements and the trapezoidal hitting elements each have at least two sides with coinciding length.

11. A method of using a micronization device, according to claim 1, wherein:
said method of using produces in particles having a particle size between 0.1 and 5 μm.

12. A method of using a micronization device, according to claim 1, wherein:
said method of using results in the micronization of crystalline substances, and the resulting crystalline substances having a surface with a portion of at least 9% amorphous surface.

13. A method of using a micronization device, according to claim 12, wherein:
said method of using results with said surface with a portion of at least 19% amorphous surface.

14. A method of micronization of a substance, comprising the steps of:
providing a micronization device, operative for the micronization of substances, comprising:
a first and a second rotors driven in a direction (w) opposite to each other;
each said rotor carrying at least one row of a plurality of hitting elements forming a ring;
respective said rings being arranged concentrically in the rings of the different rotors engaging alternately with one another;
said hitting elements being suitably arranged to provide transportation of the substances from an inside of the rings to an outside of the rings by effecting a suitable airflow therealong;
at least two directly adjoining rings carrying said hitting elements with different foot print characterized in that at least a first ring is equipped with trapezoidal hitting elements with trapezoidal foot print and at least one other ring, directly adjoining the first ring, is equipped with a plurality of triangular hitting elements with triangular foot print; and
operating said micronization device resulting in a micronization of said substance
